(19) United States
(12) Patent Application Publication
(10) Pub. No.: US 2024/0114588 A1
(43) Pub. Date: Apr. 4, 2024

(54) MESSAGE FOR NETWORK ENTITY DISCONTINUOUS RECEPTION OR DISCONTINUOUS TRANSMISSION

(71) Applicant: QUALCOMM Incorporated, San Diego, CA (US)

(72) Inventors: Konstantinos DIMOU, New York, NY (US); Shankar KRISHNAN, San Diego, CA (US)

(21) Appl. No.: 18/343,261

(22) Filed: Jun. 28, 2023

Related U.S. Application Data
(60) Provisional application No. 63/377,591, filed on Sep. 29, 2022.

(51) Int. Cl. H04W 76/28; H04W 72/0446; H04W 72/1263; H04W 72/20

(52) U.S. Cl. CPC H04W 76/28; H04W 72/0446; H04W 72/1263; H04W 72/20

(57) ABSTRACT

Various aspects of the present disclosure generally relate to wireless communication. In some aspects, a first network entity may transmit a first message to a neighboring second network entity, where the first message indicates one or more of a discontinuous reception (DRX) timing of the first network entity or a discontinuous transmission (DTX) timing of the first network entity. The first network entity may start at least one of a DRX mode according to the DRX timing or a DTX mode according to the DTX timing. The second network entity may adjust communication scheduling or a measurement configuration. Numerous other aspects are described.

### CROSS-REFERENCE TO RELATED APPLICATION

This patent application claims priority to U.S. Provisional Patent Application No. 63/377,591, filed on Sep. 29, 2022, entitled “MESSAGE FOR NETWORK ENTITY DISCONTINUOUS RECEPTION OR DISCONTINUOUS TRANSMISSION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for messaging for network entity discontinuous reception or discontinuous transmission.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus of a first network entity. The method may include transmitting a first message to a second network entity, where the first message indicates one or more of a discontinuous reception (DRX) timing of the first network entity or a discontinuous transmission (DTX) timing of the first network entity. The method may include starting at least one of a DRX mode according to the DRX timing or a DTX mode according to the DTX timing.

Some aspects described herein relate to a method of wireless communication performed by an apparatus of a second network entity. The method may include receiving, from a first network entity, a first message that indicates one or more of a DRX timing of the first network entity or a DTX timing of the first network entity. The method may include adjusting one or more of communication scheduling or a measurement configuration based at least in part on the one or more of the DRX timing or the DTX timing.

Some aspects described herein relate to an apparatus of a first network entity for wireless communication. The apparatus may include one or more memories and one or more processors coupled to the one or more memories. The one or more processors may be individually or collectively configured to cause the first network entity to transmit a first message to a second network entity, where the first message indicates one or more of a DRX timing of the first network entity or a DTX timing of the first network entity. The one or more processors may be individually or collectively configured to cause the first network entity to start at least one of a DRX mode according to the DRX timing or a DTX mode according to the DTX timing.

Some aspects described herein relate to an apparatus of a second network entity for wireless communication. The apparatus may include one or more memories and one or more processors coupled to the one or more memories. The one or more processors may be individually or collectively configured to cause the second network entity to receive, from a first network entity, a first message that indicates one or more of a DRX timing of the first network entity or a DTX timing of the first network entity. The one or more processors may be individually or collectively configured to cause the second network entity to adjust one or more of communication scheduling or a measurement configuration based at least in part on the one or more of the DRX timing or the DTX timing.

Some aspects described herein relate to a non-transitory computer-readable medium that stores a set of instructions for wireless communication by a first network entity. The set of instructions, when executed by one or more processors of the first network entity, may cause the first network entity to transmit a first message to a second network entity, where the first message indicates one or more of a DRX timing of the first network entity or a DTX timing of the first network entity. The set of instructions, when executed by one or more processors of the first network entity, may cause the first network entity to start at least one of a DRX mode according to the DRX timing or a DTX mode according to the DTX timing.

Some aspects described herein relate to a non-transitory computer-readable medium that stores a set of instructions for wireless communication by a second network entity. The set of instructions, when executed by one or more processors of the second network entity, may cause the second network entity to receive, from a first network entity, a first message that indicates one or more of a DRX timing of the first network entity or a DTX timing of the first network entity. The set of instructions, when executed by one or more processors of the second network entity, may cause the second network entity to adjust one or more of communication scheduling or a measurement configuration based at least in part on the one or more of the DRX timing or the DTX timing.

Some aspects described herein relate to an apparatus for wireless communication. The apparatus may include means for transmitting a first message to another apparatus, where the first message indicates one or more of a DRX timing of the apparatus or a DTX timing of the apparatus. The apparatus may include means for starting at least one of a DRX mode according to the DRX timing or a DTX mode according to the DTX timing.

Some aspects described herein relate to an apparatus for wireless communication. The apparatus may include means for receiving, from another apparatus, a first message that indicates one or more of a DRX timing of the other apparatus or a DTX timing of the other apparatus. The apparatus may include means for adjusting one or more of communication scheduling or a measurement configuration based at least in part on the one or more of the DRX timing or the DTX timing.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity (e.g., base station) in communication with a UE in a wireless network, in accordance with the present disclosure.

FIG. 3 is a diagram illustrating an example of a disaggregated base station, in accordance with the present disclosure.

FIG. 4 is a diagram illustrating an example of downlink semi-persistent scheduling communication and an example of uplink configured grant communication, in accordance with the present disclosure.

FIG. 5 is a diagram illustrating an example of using a transmit inactivity period, in accordance with the present disclosure.

FIG. 6 is a diagram illustrating examples of transmit inactivity periods, in accordance with the present disclosure.

FIG. 7 is a diagram illustrating examples of downlink control information formats, in accordance with the present disclosure.

FIG. 8 is a diagram illustrating an example of a network entity that may enter a transmit inactivity state, in accordance with the present disclosure.

FIG. 9 is a diagram illustrating an example of a message indicating a discontinuous reception timing or a discontinuous transmission timing, in accordance with the present disclosure.

FIG. 10 is a diagram illustrating an example process performed, for example, by a network entity, in accordance with the present disclosure.

FIG. 11 is a diagram illustrating an example process performed, for example, by a network entity, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

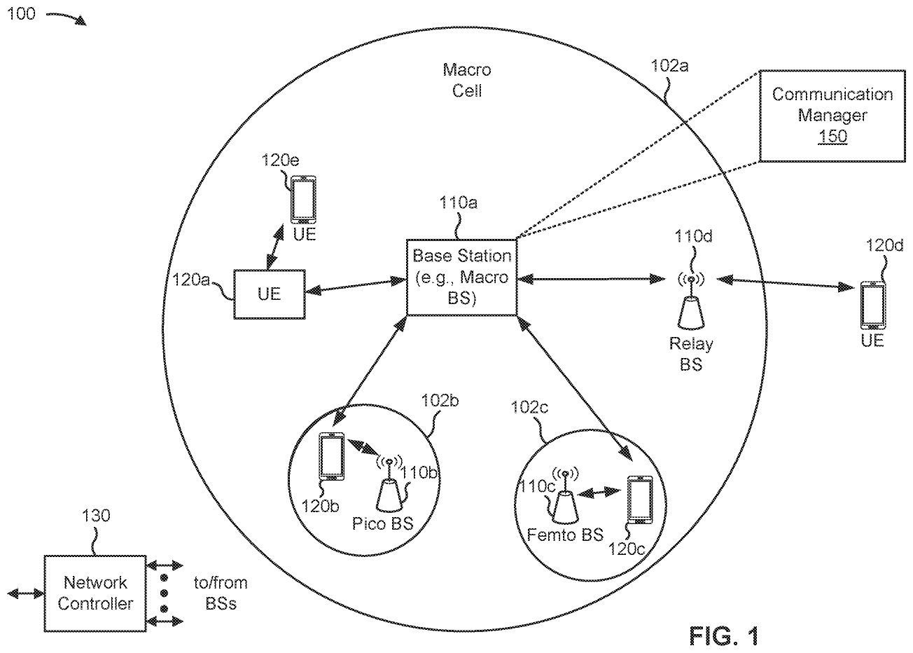

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Entity B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the terms “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the terms “base station” or “network entity” may refer to one device configured to perform one or more functions, such as those described herein in connection with the base station 110. In some aspects, the terms “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the terms “base station” or “network entity” may refer to any one or more of those different devices. In some aspects, the terms “base station” or “network entity” may refer to one or more virtual base stations and/or one or more virtual base station functions. For example, in some aspects, two or more base station functions may be instantiated on a single device. In some aspects, the terms “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BS s, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first network entity (e.g., base station 110) may include a communication manager 150. As described in more detail elsewhere herein, the communication manager 150 may transmit a first message to a second network entity, where the first message indicates one or more of a discontinuous reception (DRX) timing of the first network entity or a discontinuous transmission (DTX) timing of the first network entity. The communication manager 150 may start at least one of a DRX mode according to the DRX timing or a DTX mode according to the DTX timing.

In some aspects, a second network entity (e.g., base station 110) may include a communication manager 150. As described in more detail elsewhere herein, the communication manager 150 may receive, from a first network entity, a first message that indicates one or more of a DRX timing of the first network entity or a DTX timing of the first network entity. The communication manager 150 may adjust one or more of communication scheduling or a measurement configuration based at least in part on the one or more of the DRX timing or the DTX timing. Additionally, or alternatively, the communication manager 150 may perform one or more other operations described herein.

As indicated above, FIG. 1 is provided as an example. Other examples may differ from what is described with regard to FIG. 1.

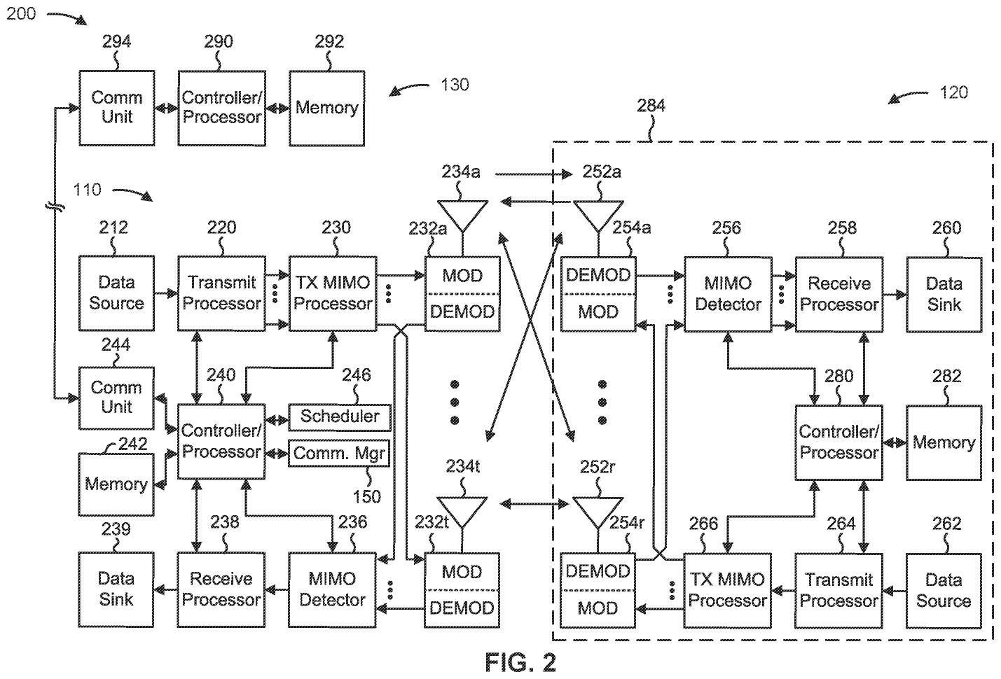

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

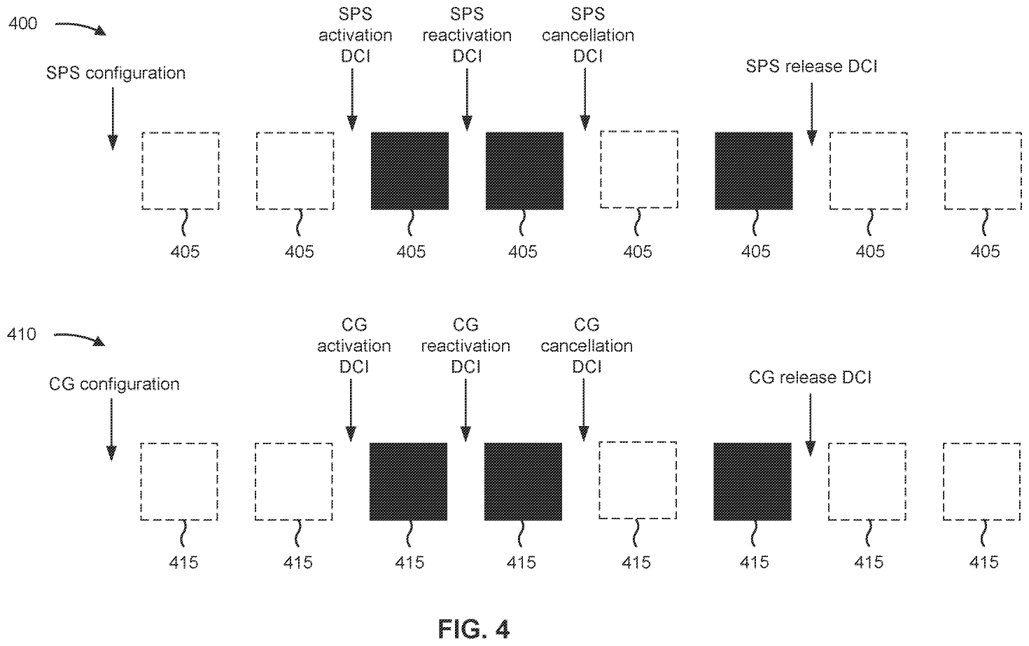

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-12).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-12).

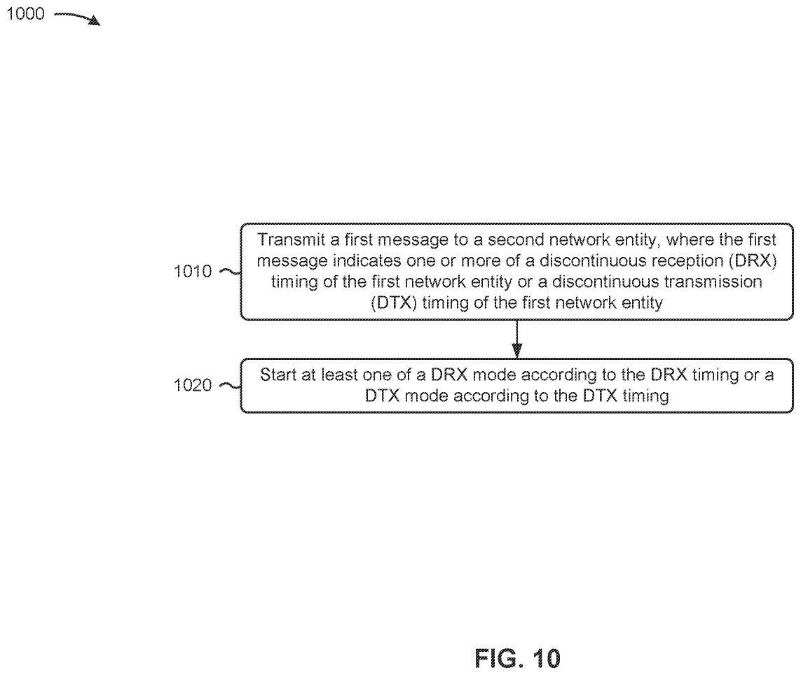

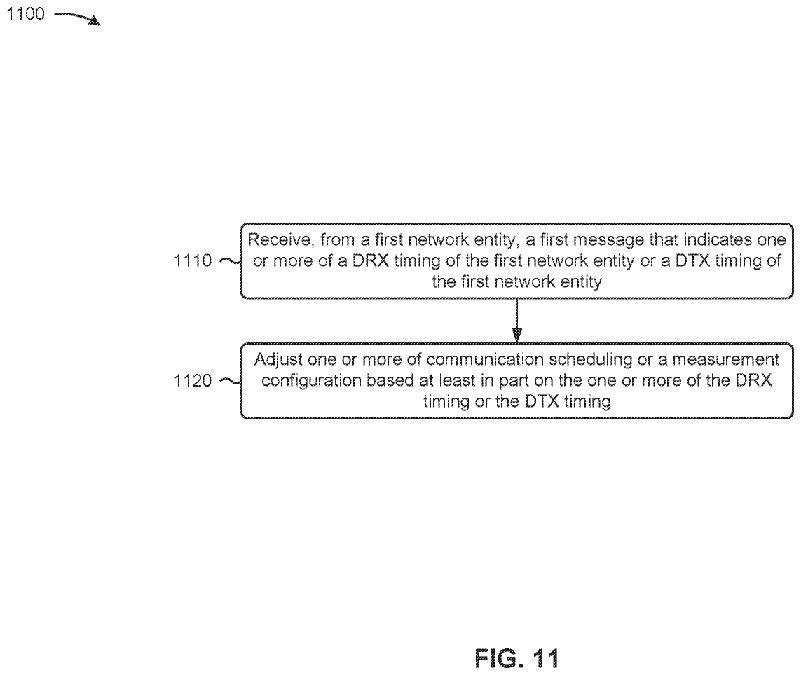

A controller/processor of a network entity (e.g., the controller/processor 240 of the base station 110), the controller/processor 280 of the UE 120, and/or any other component(s) of FIG. 2 may perform one or more techniques associated with messaging for network entity DRX or DTX, as described in more detail elsewhere herein. For example, the controller/processor 240 of the base station 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a first network entity (e.g., base station 110) includes means for transmitting a first message to a second network entity, where the first message indicates one or more of a DRX timing of the first network entity or a DTX timing of the first network entity; and/or means for starting at least one of a DRX mode according to the DRX timing or a DTX mode according to the DTX timing. In some aspects, the means for the first network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a second network entity (e.g., base station 110) includes means for receiving, from a first network entity, a first message that indicates one or more of a DRX timing of the first network entity or a DTX timing of the first network entity; and/or means for adjusting one or more of communication scheduling or a measurement configuration based at least in part on the one or more of the DRX timing or the DTX timing.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

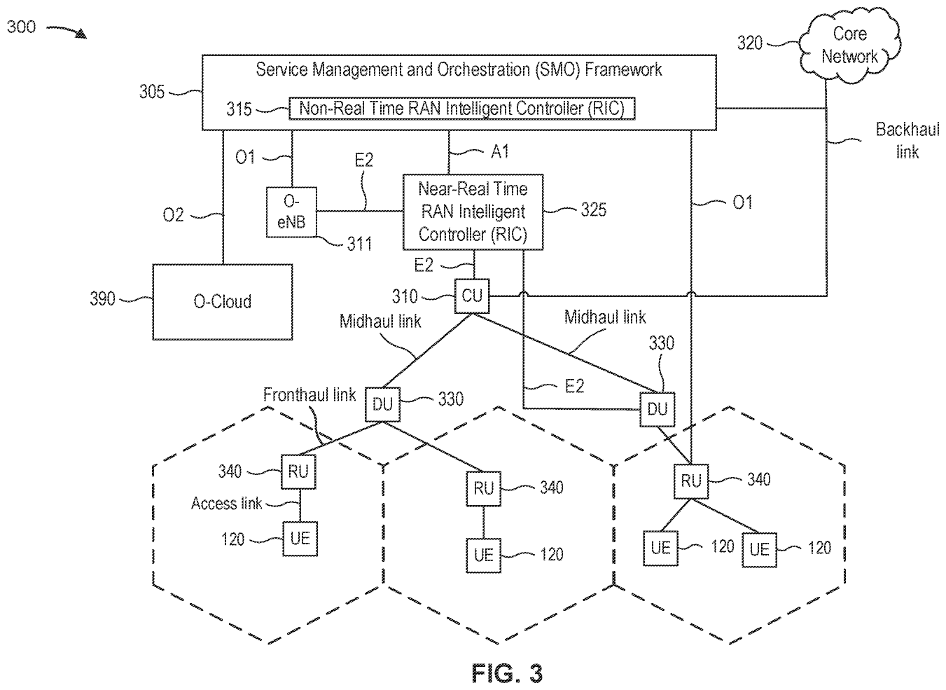

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram illustrating an example 400 of downlink semi-persistent scheduling (SPS) communication and an example 410 of uplink configured grant (CG) communication, in accordance with the present disclosure. SPS communications may include periodic downlink communications that are configured for a UE, such that a network entity does not need to transmit (e.g., directly or via one or more network entities) separate downlink control information (DCI) to schedule each downlink communication, thereby conserving signaling overhead. CG communications may include periodic uplink communications that are configured for a UE, such that the network entity does not need to transmit (e.g., directly or via one or more network entities) separate DCI to schedule each uplink communication, thereby conserving signaling overhead.

As shown in example 400, a UE may be configured with an SPS configuration for SPS communications. For example, the UE may receive the SPS configuration via an RRC message transmitted by a network entity (e.g., directly to the UE or via one or more network entities). The SPS configuration may indicate a resource allocation associated with SPS downlink communications (e.g., in a time domain, frequency domain, spatial domain, and/or code domain) and a periodicity at which the resource allocation is repeated, resulting in periodically reoccurring scheduled SPS occasions 405 for the UE. The SPS configuration may also configure hybrid automatic repeat request (HARQ)-acknowledgement (ACK) (HARQ-ACK) feedback resources for the UE to transmit HARQ-ACK feedback for SPS physical downlink shared channel (PDSCH) communications received in the SPS occasions 405.

The network entity may transmit SPS activation DCI to the UE (e.g., directly or via one or more network entities) to activate the SPS configuration for the UE. The network entity may indicate, in the SPS activation DCI, communication parameters, such as an MCS, a resource block (RB) allocation, and/or antenna ports, for the SPS PDSCH communications to be transmitted in the scheduled SPS occasions 405. The UE may begin monitoring the SPS occasions 405 based at least in part on receiving the SPS activation DCI. The UE may refrain from monitoring configured SPS occasions 405 prior to receiving the SPS activation DCI. The network entity may transmit SPS reactivation DCI to the UE (e.g., directly or via one or more network entities) to change the communication parameters for the SPS PDSCH communications.

In some cases, such as when there is no downlink traffic to transmit to the UE, the network entity may transmit SPS cancellation DCI to the UE (e.g., directly or via one or more network entities) to temporarily cancel or deactivate one or more subsequent SPS occasions 405 for the UE. The SPS cancellation DCI may deactivate only a subsequent one SPS occasion 405 or a subsequent N SPS occasions 405 (where N is an integer). SPS occasions 405 after the one or more (e.g., N) SPS occasions 405 subsequent to the SPS cancellation DCI may remain activated. Based at least in part on receiving the SPS cancellation DCI, the UE may refrain from monitoring the one or more (e.g., N) SPS occasions 405 subsequent to receiving the SPS cancellation DCI. The network entity may transmit SPS release DCI to the UE (e.g., directly or via one or more network entities) to deactivate the SPS configuration for the UE. The UE may stop monitoring the scheduled SPS occasions 405 based at least in part on receiving the SPS release DCI.

As shown in example 410, a UE may be configured with a CG configuration for CG communications. For example, the UE may receive the CG configuration via an RRC message transmitted by a network entity (e.g., directly to the UE or via one or more network entities). The CG configuration may indicate a resource allocation associated with CG uplink communications (e.g., in a time domain, frequency domain, spatial domain, and/or code domain) and a periodicity at which the resource allocation is repeated, resulting in periodically reoccurring scheduled CG occasions 415 for the UE. In some examples, the CG configuration may identify a resource pool or multiple resource pools that are available to the UE for an uplink transmission. The CG configuration may configure contention-free CG communications (e.g., where resources are dedicated for the UE to transmit uplink communications) or contention-based CG communications (e.g., where the UE contends for access to a channel in the configured resource allocation, such as by using a channel access procedure or a channel sensing procedure).

The network entity may transmit CG activation DCI to the UE (e.g., directly or via one or more network entities) to activate the CG configuration for the UE. The network entity may indicate, in the CG activation DCI, communication parameters, such as an MCS, an RB allocation, and/or antenna ports, for the CG physical uplink shared channel (PUSCH) communications to be transmitted in the scheduled CG occasions 415. The UE may begin transmitting in the CG occasions 415 based at least in part on receiving the CG activation DCI.

The network entity may transmit CG reactivation DCI to the UE (e.g., directly or via one or more network entities) to change the communication parameters for the CG PUSCH communications. Based at least in part on receiving the CG reactivation DCI, the UE may begin transmitting in the scheduled CG occasions 415 using the communication parameters indicated in the CG reactivation DCI. In some cases, such as when the network entity is expected to override a scheduled CG communication for a higher priority communication, the network entity may transmit CG cancellation DCI to the UE (e.g., directly or via one or more network entities) to temporarily cancel or deactivate one or more subsequent CG occasions 415 for the UE. The network entity may transmit CG release DCI to the UE (e.g., directly or via one or more network entities) to deactivate the CG configuration for the UE. The UE may stop transmitting in the scheduled CG occasions 415 based at least in part on receiving the CG release DCI.

As indicated above, FIG. 4 is provided as an example. Other examples may differ from what is described with respect to FIG. 4.

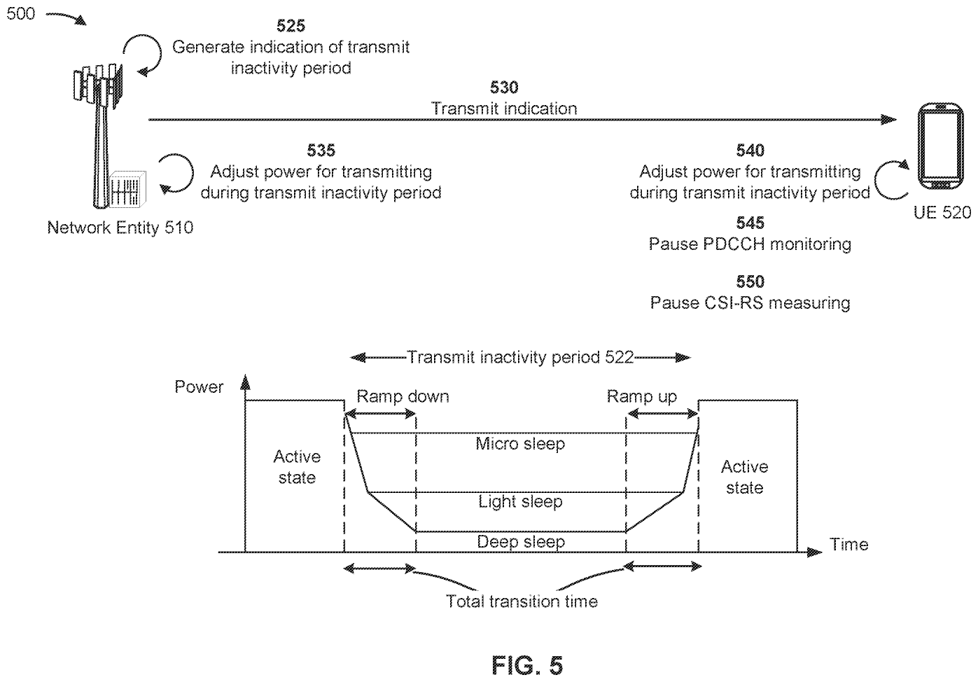

FIG. 5 is a diagram illustrating an example 500 of using a transmit inactivity period, in accordance with the present disclosure. Example 500 shows a network entity 510 (e.g., base station 110) and a UE 520 (e.g., UE 120) that may communicate with each other via a wireless network (e.g., wireless network 100).

Energy costs make up a large percentage of the operating costs for a network. Accordingly, networks are being designed to be more energy efficient and environmentally responsible. These designs may include the use of a sleep state by the network entity 510, where the network entity 510 powers down radio components or other components (partially or fully) at times to reduce energy consumption.

In some aspects, the network entity 510 may indicate a transmit inactivity period that allows the network entity 510 and/or the UE 520 more opportunities than current network configurations to enter a sleep state and thus consume less energy. The network entity 510 may indicate this transmit inactivity period to UEs. As a result, the network entity 510 and UEs 520 served by the network entity 510 may have more opportunities to sleep and to reduce power consumption.

In some implementations, the transmit inactivity period may be indicated as a pattern (e.g., a pattern of inactive BS TX Inactive states relative to active states), and the pattern may be a dynamic pattern or a periodic pattern. The network entity 510 may indicate the dynamic pattern via an RRC message and/or Layer 1 (L1) signaling (e.g., DCI, a MAC control element (MAC CE)). For example, the network entity 510 may use RRC signaling to configure the UE 520 with the option of transmitting group common DCI in the cell to indicate the “BS TX Inactive” state. The group common DCI may trigger the start and duration of the “BS TX Inactive” state. UEs may then pause monitoring for physical downlink control channel (PDCCH) communications and pause measuring periodic or semi-persistent channel state information reference signals (CSI-RS s) (if configured) during the “BS TX Inactive” state (or mode). The time duration during which the network entity 510 is in the BS TX Inactive state may be referred to as a network “transmit inactivity period.” The transmit inactivity period may be a period between active states or a period when the network entity 510 is powered down below a threshold power level. Example 500 shows an example transmit inactivity period 522.

In some aspects, the network entity 510 may define, trigger, and/or configure one or more transmit inactivity periods for the BS TX Inactive state without affecting downlink traffic performance. However, before initiating (and indicating) a transmit inactivity period, the network entity 510 may check whether one or more conditions are satisfied. If the conditions are satisfied, the network entity 510 may generate an indication of a transmit inactivity period, as shown by reference number 525. For example, the network entity 510 may generate the indication if a condition is satisfied where there is no downlink traffic with a latency requirement that is less than the period (time duration) of the transmit inactivity period (in the cell or in neighbor cells) and there is no periodic downlink traffic (e.g., SPS traffic) with a period that is shorter than the period of the transmit inactivity period. In other words, the network entity 510 may check that there is no low-latency downlink traffic to be transmitted. If there is such downlink traffic, the network entity may not initiate or indicate a transmit inactivity period.

While the network entity 510 may check for downlink traffic, the network entity may also check for uplink traffic because of the downlink traffic that is associated with scheduling the uplink traffic. For example, the network entity 510 may generate the indication (and initiate the BS TX Inactive state) if a condition is satisfied where there is no uplink traffic with a latency requirement that is less than the period of the transmit inactivity period, no uplink traffic is dynamically scheduled (via DCI), and retransmissions are allowed (via DCI) (in the current cell or in neighbor cells). The network entity 510 may generate the indication if a condition is satisfied where there is no periodic uplink traffic (e.g., CG) with a period that is shorter than the period of the transmit inactivity period and retransmissions are configured. If there is such uplink traffic, the network entity may not initiate or indicate a transmit inactivity period. Note that the network entity 510 may ensure that a synchronization signal block (SSB) is not skipped if certain types of UEs are present (e.g., UEs that use features specified by 3GPP Release 17) and that radio access channel (RACH) occasions (ROs) are not skipped. The network entity 510 may be aware of the above conditions by using Release 17 signaling procedures (e.g., RRC signaling, DCI, a MAC CE).

If the above conditions for downlink traffic and uplink traffic are satisfied, the network entity 510 may generate the indication of a transmit inactivity period. During the transmit inactivity period, the network entity 510 may also adjust the transmit power of the network entity 510. This may include, for example, reducing power of the network entity 510 for transmitting during the transmit inactivity period. The reduction of the power for transmitting may be part of entering an inactive state or a sleep state. By contrast, an active state or awake state may include a state of processing (e.g., decoding and/or demodulating) downlink signals, uplink signals, and/or channels. The amount of power that the network entity 510 consumes during an awake state may scale (increase or decrease) based at least in part on a quantity of component carriers (CCs), resource utilization, a quantity of antenna ports, a quantity of spatial layers, and/or a quantity of antenna elements.

Example 500 also shows how the network entity 510 may ramp power down from an active state to a sleep state and ramp power back up to an active state. As the time between active states increases, more components can be turned off (power withdrawn) to conserve more power, including a radio (radio components) that is used for transmission and/or reception. For example, the network entity 510 may switch off the radio frequency (RF) part and/or a broadband part of a transmit chain, such that the network entity 510 will not transmit any communications. Switching between a transmit (downlink) active state (transmitting) and a transmit inactive state (not transmitting) may be an operation of a DTX mode, also referred to as “BS in DTX mode.” The transmit active state of the network entity 510 may be referred to as a “BS transmit active” state, and the inactive transmit state of the network entity 510 may be referred to as a “BS TX inactive” state. During the inactive transmit state, there are no downlink transmissions and the network entity 510 can enter a sleep state. During the active transmit state, downlink transmissions are possible, and the network entity 510 cannot enter the sleep state.

The network entity 510 may reduce power by varying amounts. For example, a sleep state may include varying levels of sleep, such as a micro sleep, a light sleep, or a deep sleep. A micro sleep may cause the network entity 510 to use a reduced amount of power for the radio as compared to the active state. This reduction in power may be much less than the reduction in power for a deep sleep (e.g., a deep sleep may have a reduction in power that is 15 times that of a micro sleep). However, a micro sleep may have very little transition time (e.g., less than 1 millisecond (ms)) and may use little transition energy. A light sleep may be a sleep level between a micro sleep and a deep sleep, with a power reduction that is, for example, half that of a deep sleep. A light sleep may have a slower transition time (e.g., 6 ms) than a micro sleep, but may still be quicker than a deep sleep. A light sleep may cause the network entity 510 to use additional transition energy (relative power vs. ms) that can be about 20 times that of a micro sleep. A deep sleep may have the longest sleep period and/or the greatest energy reduction. The deep sleep may also have the longest transition time (e.g., 20 ms) and cause the network entity 510 to use the greatest amount of energy for transition (e.g., about 100 times that of the micro sleep).

As shown by reference number 530, the network entity 510 may transmit the indication. The indication may specify a periodic BS DTX pattern, with “BS Tx Active” and “BS Tx Inactive” durations, or a dynamic BS DTX pattern, in which “BS Tx Inactive” periods are triggered dynamically by the network entity 510.

As shown by reference number 535, the network entity 510 may adjust a power (e.g., decrease power, set a new power) for transmitting based at least in part on the indication. This may include adjusting the power to be at a reduced level during the transmit inactivity period. For example, as shown by reference number 540, the UE 520 may adjust a power for receiving during the transmit inactivity period. The UE 520 may use the indication of the transmit inactivity period to reduce power to a receiving radio (e.g., enter a sleep state), or perform other operations that do not involve the network entity 510, during the transmit inactivity period of the network entity 510. During the transmit inactivity period, the UE 520 may pause (refrain from) actions such as PDCCH monitoring (shown by reference number 545) and/or CSI-RS measuring (shown by reference number 550). This is because during the transmit inactivity period, the network entity 510 may not transmit PDCCH communications, periodic CSI-RSs, and semi-persistent CSI-RSs. In this way, the network entity 510 may reduce power consumption. The UE 520 may also reduce power consumption and conserve battery power.

If the UE 520 exits the transmit inactivity period, the UE 520 may remain in an active state (e.g., awake) for the duration of an inactivity timer (e.g., which may extend the active time). The UE 120 may start the inactivity timer at a time at which the PDCCH communication is received (e.g., in a transmission time interval in which the PDCCH communication is received, such as a slot or a subframe). The UE 520 may remain in the active state until the inactivity timer expires, at which time the UE 520 may enter the sleep state (e.g., for the inactive transmit time). During the duration of the inactivity timer, the UE 520 may continue to monitor for PDCCH communications, may obtain a downlink data communication (e.g., on a downlink data channel, such as a PDSCH) scheduled by the PDCCH communication, and/or may prepare and/or transmit an uplink communication (e.g., on a PUSCH) scheduled by the PDCCH communication. The UE 520 may restart the inactivity timer after each detection of a PDCCH communication for the UE 520 for an initial transmission (e.g., but not for a retransmission).

In some aspects, the network entity 510 may utilize an inactive receive time or a “BS in DRX mode,” where DRX is discontinuous reception. The receive inactive state of the network entity 510 may be referred to as a “BS Rx Inactive” state or a receive inactivity period. In the receive inactivity period, the network entity 510 may cause radio receiver components or other components to enter a sleep state (e.g., micro sleep, light sleep, deep sleep).

As indicated above, FIG. 5 is provided as an example. Other examples may differ from what is described with respect to FIG. 5.

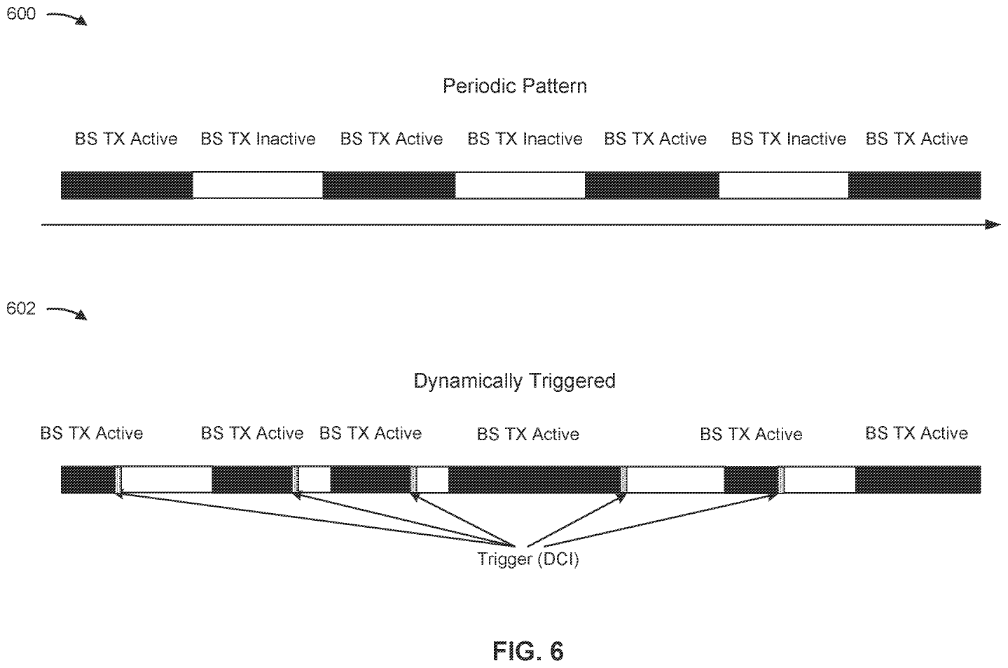

FIG. 6 is a diagram illustrating examples 600 and 602 of transmit inactivity periods, in accordance with the present disclosure.

Example 600 shows a periodic DTX pattern of inactive transmit states (BS TX Inactive), each inactive transmit state having a transmit inactivity period. The network entity 510 may transmit the indication of the transmit inactivity period using, for example, RRC signaling. This may include via system information (SI) or via dedicated RRC signaling.

Example 602 shows dynamically triggered transmit inactivity states, where a triggering DCI indicates a timing of one or more transmit inactivity states. This may include a combination of RRC signaling and L1 signaling. The RRC level configuration may configure the option of having transmit inactivity periods and a list of N transmit inactivity periods with associated parameters (e.g., starting slot offset, duration), as part of a DTX pattern. The RRC signaling may include information about the periodic DTX pattern or DTX configurations in an information element (IE) in a system information block (SIB). The DCI may trigger one of the N RRC configured transmit inactivity periods. In case of signaling via an SIB, paging to UEs is expected and an update of a DTX pattern is possible only after a paging cycle. The minimum value of a paging cycle may be 32 radio frames.

For both the periodic DTX pattern and the dynamic DTX pattern, the start of a transmit inactivity period implies that UEs do not monitor for PDCCH communications and do not perform CSI-RS measurements (of all types). In some aspects, the set or list of configured transmit inactivity periods may be reconfigured. In some aspects, the network entity 510 may switch from a periodic DTX pattern to a dynamic DTX pattern. DRX may follow similar patterns.

As indicated above, FIG. 6 provides some examples. Other examples may differ from what is described with regard to FIG. 6.

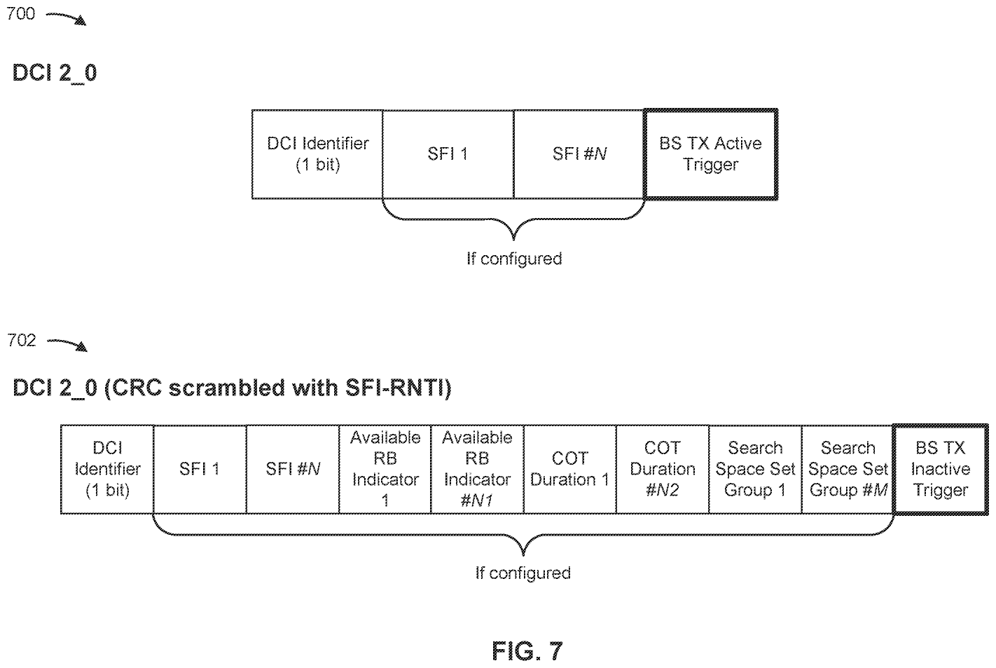

FIG. 7 is a diagram illustrating examples 700 and 702 of DCI formats, in accordance with the present disclosure.

Example 700 shows a DCI format 2_0 for signaling a transmit inactivity period. The DCI format may include a DCI identifier (ID) and slot format indicators (SFIs), if configured. The DCI may further include a BS TX Inactive trigger. The BS TX Inactive trigger may indicate one of multiple preconfigured DTX patterns that may include a starting slot offset (e.g., a starting slot or sub-slot from a current slot) and/or a duration (e.g., quantity of slots or sub-slots).

Example 702 shows a DCI format 2_0 that may be scrambled with an SFI radio network temporary identifier (RNTI). This may include up to 128 bits. The DCI may include information for SFIs, RBs, channel occupancy time (COT), and search space set groups, if configured. The DCI may further include a BS TX Inactive trigger. The BS TX Inactive trigger may indicate a starting slot offset and/or a duration. By triggering transmit inactivity states, the network entity 510 may increase the opportunities to enter the sleep state and reduce power consumption.

As indicated above, FIG. 7 is provided as an example. Other examples may differ from what is described with regard to FIG. 7.

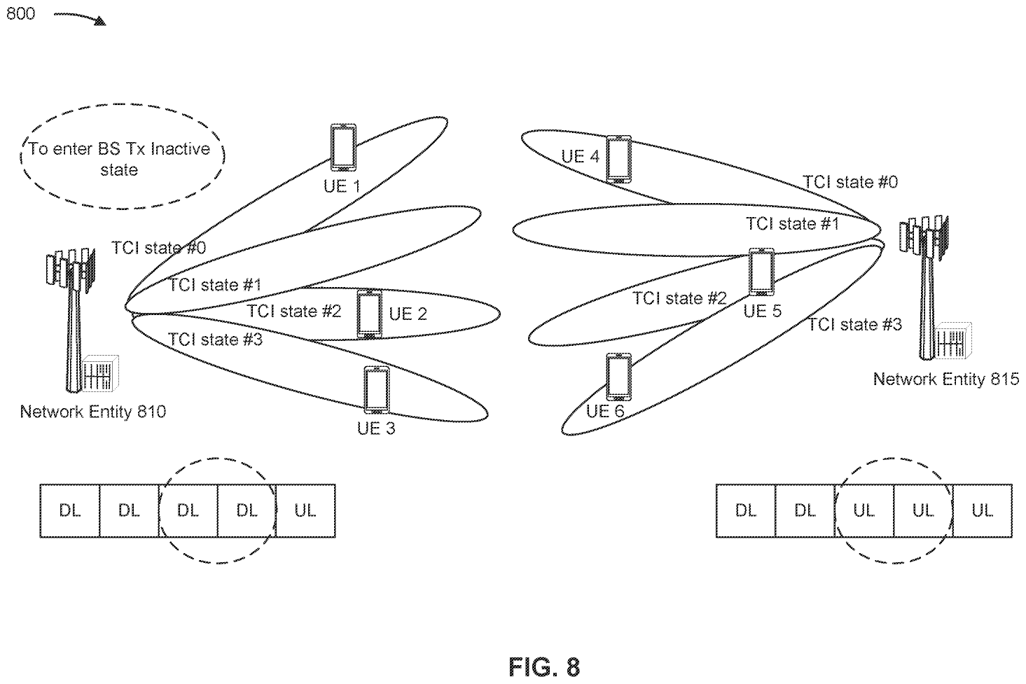

FIG. 8 is a diagram illustrating an example 800 of a network entity that may enter a transmit inactivity state, in accordance with the present disclosure. A first network entity 810 (e.g., base station 110) and a second network entity 815 (e.g., base station 110) may transmit multiple beams to multiple UEs. Each beam may be associated with a transmission configuration indicator (TCI) state. The network entity 810 may determine to enter a transmit inactivity state during two downlink slots of a configured slot pattern. Network entity 815 may be scheduled to receive uplink communications during these slots and other slots. The UEs served by network entity 815 may be scheduled to transmit with a higher transmit power during these slots in anticipation of interference from communications involving network entity 810. However, network entity 810 is entering a DTX mode and a DRX mode during these slots. Network entity 815 is not aware of the upcoming DTX mode and DRX mode of network entity 810. Consequently, the UEs communicating with network entity 815 may consume more energy than necessary when transmitting with a higher transmit power when no other communications with network entity 810 are scheduled. Furthermore, communications involving network entity 810 may interfere with communications involving network entity 815 in other slots. Such interference may degrade communications and waste processing resources and signaling resources. Network entity 810 may transmit a deactivation message when deactivating but the deactivation message may be too infrequent for network entity 815 to effectively conserve energy. The Xn message payload may also be large and frequent exchanges may consume a significant amount of signaling resources if the deactivation message is transmitted for each switch to a transmit inactivity state.

As indicated above, FIG. 8 is provided as an example. Other examples may differ from what is described with regard to FIG. 8.

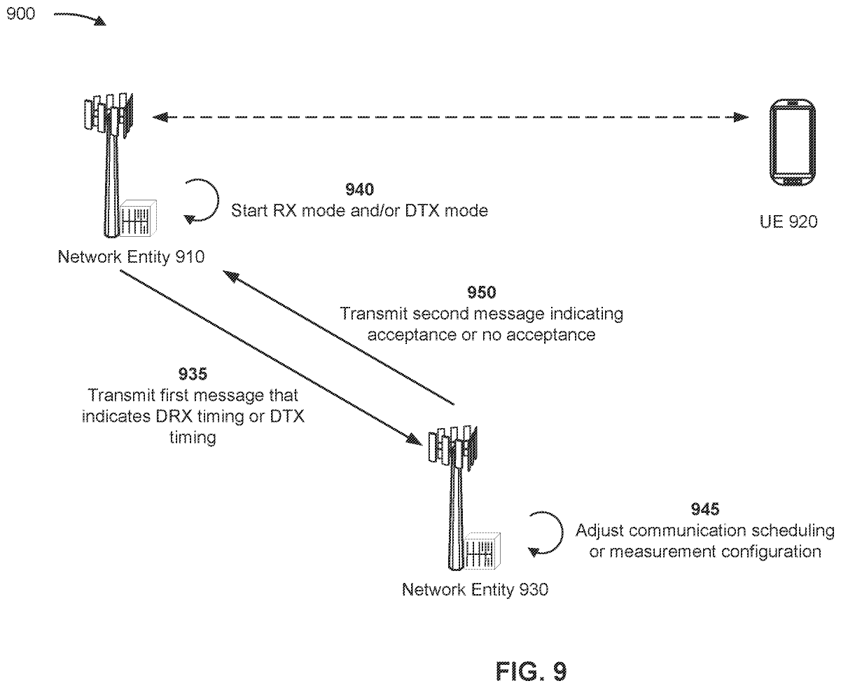

FIG. 9 is a diagram illustrating an example 900 of a message indicating a DRX timing or a DTX timing, in accordance with the present disclosure. Example 900 shows a network entity 910 (e.g., base station 110) and a UE 920 (e.g., UE 120) that may communicate with each other via a wireless network (e.g., wireless network 100). Network entity 910 may be a serving cell. Network entity 910 may also communicate with network entity 930 over an Xn application protocol (XnAP) interface. Network entity 930 may be a neighboring network entity to network entity 910. For example, some UEs served by network entity 910 may also be served by or interfere with UEs served by network entity 930.

According to various aspects described herein, network entity 910 may transmit a first message to network entity 930, as shown by reference number 935. The first message may indicate a DRX timing of a DRX mode or a DTX timing of a DTX mode of network entity 910. The DRX timing may indicate a pattern (e.g., periodicity) for a DRX mode, such as when the network entity 930 is in a receive inactivity state for a receive inactivity period of the DRX mode and when the network entity 930 is in a receive activity state (on duration) for a receive activity period of a DRX mode. The pattern or periodicity may include an interval of activity periods between inactivity periods, or a length of a cycle. The DTX timing may indicate a pattern (e.g., periodicity) for a DRX mode, such as when the network entity 930 is in a transmit inactivity state (on duration) for a transmit inactivity period of a DTX mode and when the network entity 930 is in a transmit activity state for a transmit activity period of the DTX mode. The first message may be a modification of an existing information element (IE) for served cells that is transmitted by network entity 910 or a message specific to indicating a DRX timing or a DTX timing. The first message may indicate a semi-persistent pattern for DTX, a dynamic pattern for DTX, a semi-persistent pattern for DRX, and/or a dynamic pattern for DRX. Semi-persistent may include semi-static or periodic. Network entity 910 may transmit the first message via RRC or L1 signaling.

In some aspects, the DRX timing may include parameters, such as a starting slot for the DRX mode and an ending slot for the DRX mode. The DTX timing may include parameters, such as a starting slot for a DTX mode and an ending slot for the DTX mode. The parameters may include a duration (e.g., quantity of slots, milliseconds (ms)) for the DRX mode or the DTX mode. The duration may indicate the ending slot. That is, given a starting slot and a duration, the ending slot may be determined (implicitly indicated). Parameters may also include a starting slot offset of a cycle.

The pattern for DRX and/or the pattern for DTX may be periodic or follow a specified frequency or timing. Alternatively, the pattern may be dynamic (indicate a present pattern and not a periodic pattern). The indication of a dynamic pattern may be transmitted when a network entity transmit inactivity state or a network entity receive inactivity state is triggered and if a backhaul is available. If the pattern is dynamic, the starting slot (first slot) may be a current slot or a slot that has already occurred (e.g., negative slot value). The starting slot may be retroactive, where one or more network entity transmit inactive states and/or network entity receive inactive states are reported (e.g., reportedSignaling support). The pattern may be among network entities (e.g., inter-gNB coordination) or within a split-network entity (e.g., intra-gNB coordination, disaggregated base station coordination).

In some aspects, the first message may indicate a different inactivity pattern or parameters (e.g., starting slot, ending slot, duration) for DRX than for DTX. Alternatively, in some aspects, the first message may indicate that the pattern or the parameters are the same for DRX as for DTX. For example, if the first message includes a starting slot, an ending slot, and an indication that the DRX pattern and the DTX pattern are the same, the DTX mode and the DRX mode for network entity 810 both start at the starting slot and end at the ending slot.

As shown by reference number 940, network entity 910 may start a DRX mode according to the DRX timing and/or a DTX mode according to the DTX timing. Using the DRX mode or the DTX mode may include reducing power to radio components as described in connection with FIG. 5. The network entity 910 may communicate based at least in part on the DRX timing or the DTX timing. For example, the network entity 910 may transmit communications before the starting slot for a DTX mode and refrain from transmitting until after the ending slot for the DTX mode. The network entity 910 may receive communications before the starting slot for the DRX mode and refrain from receiving until after the ending slot for the DRX mode.

In some aspects, as shown by reference number 950, network entity 930 may transmit a second message. The second message may be a response message in response to the first message. For example, the second message may indicate acceptance of the DRX timing or DTX timing. The second message may be a reused message, such as an NG-RAN NODE CONFIGURATION UPDATE message. The second message may be adaptive in size. For example, the second message may transmit only information related to a network entity inactivity state (e.g., a DRX mode, a DTX mode) when DRX or DTX information is to be provided. The network entity 910 may start the DRX mode and/or the DTX mode at reference number 940 based at least in part on the second message indicating acceptance or confirms the use of the DRX timing and/or the DTX timing.

In some aspects, the network entity 910 may not start the DRX mode and/or the DTX mode based at least in part on the second message indicating no acceptance of the DRX mode and the DTX mode. The network entity 910 may adjust the DRX timing of the DRX mode and/or the DTX timing of the DTX mode if the second message indicates no acceptance. The network entity 910 may also proceed with the DRX timing of the DRX mode and/or the DTX timing of the DTX mode if the second message indicates no acceptance.

As shown by reference number 945, network entity 930 may adjust communication scheduling or a measurement configuration for UEs served by network entity 930 based at least in part on the DRX timing and/or the DTX timing. For example, network entity 930 may schedule (or be more likely to schedule or prioritize scheduling) UE transmissions and/or receptions during the transmit inactivity period of the DTX mode of network entity 930 and/or the receive inactivity period of the DRX mode of the network entity 930. For example, network entity 930 may schedule data transmissions and/or CSI-RSs to UEs at cell edges or to UEs experiencing interference from neighboring network entities when network entity 910 is in a transmit inactivity state of a DTX mode. Network entity 930 may schedule an aperiodic CSI-RS (A-CSI-RS) to UEs in the cell during transmit inactivity states and/or receive inactivity states of network entity 910. Network entity 930 may be aware that the A-CSI-RS measurements will be “clean” from interference from network entity 910. Network entity 930 may not schedule (or be less likely to schedule or deprioritize scheduling) UE transmissions and/or receptions during the transmit activity period of the DTX mode of network entity 930 and/or the receive activity period of the DRX mode of the network entity 930. If the first message includes retroactive DTX or DRX information, network entity 930 may consider the DTX or DRX information when receiving CSI reports from UEs in covered cells of network entity 930.

In some aspects, network entity 930 may configure CSI interference measurement (CSI-IM) measurements (as part of a measurement configuration) for UEs served by network entity 930 based at least in part on transmit inactivity periods of a DTX mode of the network entity 910. The network entity 930 may be aware that the IM measurement is “free” from interference from network entity 910 during transmit inactivity periods of a DTX mode of the network entity 910.

In some aspects, network entity 930 may enter a DRX mode and/or a DTX mode based at least in part on the DRX mode and/or the DTX mode of network entity 910 such that there is less interference between communications of UEs served by network entity 910 and UEs served by network entity 930.

Apart from network entity 910 conserving energy when switching to a network entity inactivity state, neighboring network entities, such as network entity 930, may conserve energy and avoid interference during a transmit activity period of a DRX mode and/or a receive activity period of a DTX mode of network entity 910. By sharing a DRX timing and/or a DTX timing, a network entity may better coordinate communications and measurements with neighboring network entities to improve communications and reduce collisions and interference. As a result, the network entities may conserve power and signaling resources.

As indicated above, FIG. 9 is provided as an example. Other examples may differ from what is described with regard to FIG. 9.

FIG. 10 is a diagram illustrating an example process 1000 performed, for example, by a first network entity, in accordance with the present disclosure. Example process 1000 is an example where the first network entity (e.g., base station 110, network entity 910) performs operations associated with messaging for network entity DTX or DRX.

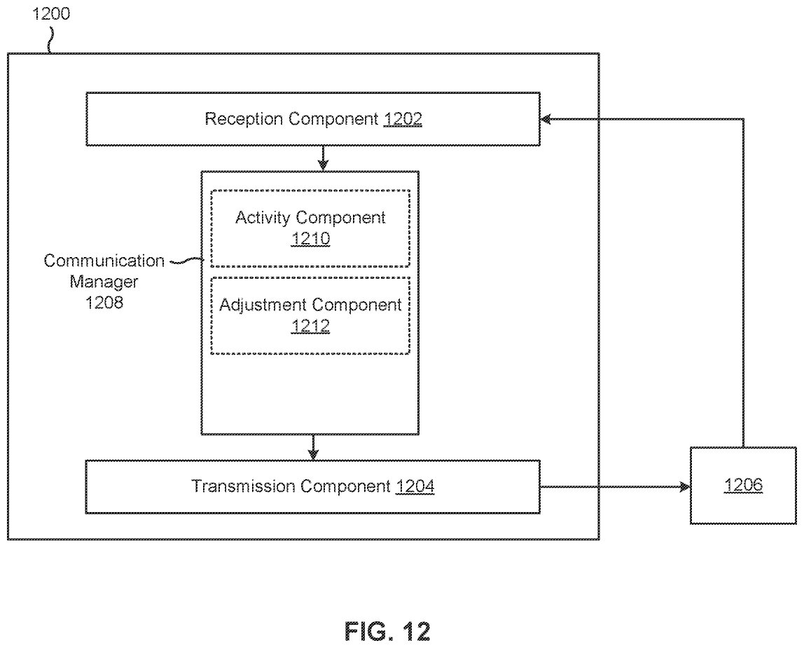

As shown in FIG. 10, in some aspects, process 1000 may include transmitting a first message to a (neighboring) second network entity, where the first message indicates one or more of a DRX timing of the first network entity or a DTX timing of the first network entity (block 1010). For example, the first network entity (e.g., using communication manager 1208 and/or transmission component 1204 depicted in FIG. 12) may transmit a first message to a second network entity, where the first message indicates one or more of a DRX timing of the first network entity or a DTX timing of the first network entity, as described above.

As further shown in FIG. 10, in some aspects, process 1000 may include starting at least one of a DRX mode according to the DRX timing or a DTX mode according to the DTX timing (block 1020). For example, the first network entity (e.g., using communication manager 1208 and/or activity component 1210 depicted in FIG. 12) may start at least one of a DRX mode according to the DRX timing or a DTX mode according to the DTX timing, as described above.

Process 1000 may include additional aspects, such as any single aspect or any combination of aspects described below and/or in connection with one or more other processes described elsewhere herein.

In a first aspect, process 1000 includes communicating based at least in part on the DRX timing or the DTX timing.

In a second aspect, alone or in combination with the first aspect, the first message indicates that the DRX timing and the DTX timing are the same and indicates a starting slot and an ending slot for the DRX timing and the DTX timing.

In a third aspect, alone or in combination with one or more of the first and second aspects, the first message indicates one or more of a starting slot and an ending slot for the DRX timing, or a starting slot and an ending slot for the DTX timing.

In a fourth aspect, alone or in combination with one or more of the first through third aspects, the first message is a node configuration update message.

In a fifth aspect, alone or in combination with one or more of the first through fourth aspects, the first message is dedicated to network entity transmission or reception activity.

In a sixth aspect, alone or in combination with one or more of the first through fifth aspects, process 1000 includes receiving, from the second network entity, a second message associated with accepting or not accepting the one or more of the DRX timing or the DTX timing indicated in the first message.

In a seventh aspect, alone or in combination with one or more of the first through sixth aspects, the second message is a node configuration update acknowledge message.

In an eighth aspect, alone or in combination with one or more of the first through seventh aspects, the second message is dedicated to providing a response associated with network entity transmission or reception activity.

In a ninth aspect, alone or in combination with one or more of the first through eighth aspects, starting the at least one of the DRX mode or the DTX mode includes starting the at least one of the DRX mode according to the DRX timing or the DTX mode according to the DTX timing based at least in part on the second message indicating acceptance of the DRX timing or the DTX timing.

In a tenth aspect, alone or in combination with one or more of the first through ninth aspects, the first message indicates one or more of a semi-persistent pattern or a dynamic pattern for DTX, or a semi-persistent pattern or a dynamic pattern for DRX.

In an eleventh aspect, alone or in combination with one or more of the first through tenth aspects, the first message indicates a first slot for the dynamic pattern for DTX, and the first slot has already occurred.

In a twelfth aspect, alone or in combination with one or more of the first through eleventh aspects, the DRX timing includes a periodicity of the DRX mode or the DTX timing includes a periodicity of the DTX mode.

In a thirteenth aspect, alone or in combination with one or more of the first through twelfth aspects, the first message indicates a DTX starting offset of a DTX cycle or a DRX starting offset of a DRX cycle.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a second network entity, in accordance with the present disclosure. Example process 1100 is an example where the second network entity (e.g., base station 110, network entity 930) performs operations associated with messaging for network entity DTX or DRX.

As shown in FIG. 11, in some aspects, process 1100 may include receiving, from a first network entity, a first message that indicates one or more of a DRX timing of the first network entity or a DTX timing of the first network entity (block 1110). For example, the second network entity (e.g., using communication manager 1208 and/or reception component 1202 depicted in FIG. 12) may receive, from a first network entity, a first message that indicates one or more of a DRX timing of the first network entity or a DTX timing of the first network entity, as described above.

As further shown in FIG. 11, in some aspects, process 1100 may include adjusting one or more of communication scheduling or a measurement configuration based at least in part on the one or more of the DRX timing or the DTX timing (block 1120). For example, the second network entity (e.g., using communication manager 1208 and/or adjustment component 1212 depicted in FIG. 12) may adjust one or more of communication scheduling or a measurement configuration based at least in part on the one or more of the DRX timing or the DTX timing, as described above.

Process 1100 may include additional aspects, such as any single aspect or any combination of aspects described below and/or in connection with one or more other processes described elsewhere herein.

In a first aspect, the first message indicates that the DRX timing and the DTX timing are the same and indicates a starting slot and an ending slot for the DRX timing and the DTX timing.

In a second aspect, alone or in combination with the first aspect, the first message indicates one or more of a starting slot and an ending slot for the DRX timing, or a starting slot and an ending slot for the DTX timing.

In a third aspect, alone or in combination with one or more of the first and second aspects, the first message is a node configuration update message.

In a fourth aspect, alone or in combination with one or more of the first through third aspects, the first message is dedicated to network entity transmission or reception activity.

In a fifth aspect, alone or in combination with one or more of the first through fourth aspects, process 1100 includes transmitting, to the first network entity, a second message associated with accepting or not accepting the one or more of the DRX timing or the DTX timing indicated in the first message.

In a sixth aspect, alone or in combination with one or more of the first through fifth aspects, process 1100 includes one or more of adjusting communication scheduling, starting a DRX mode, starting a DTX mode, or adjusting measurements based at least in part on the second message indicating acceptance of the DRX timing or the DTX timing.

In a seventh aspect, alone or in combination with one or more of the first through sixth aspects, the second message is a node configuration update acknowledge message.

In an eighth aspect, alone or in combination with one or more of the first through seventh aspects, the second message is dedicated to providing a response associated with network entity transmission or reception activity.

In a ninth aspect, alone or in combination with one or more of the first through eighth aspects, the first message indicates one or more of a semi-persistent pattern or a dynamic pattern for DTX, or a semi-persistent pattern or a dynamic pattern for DRX.

In a tenth aspect, alone or in combination with one or more of the first through ninth aspects, the first message indicates a first slot for the dynamic pattern for DTX, and the first slot has already occurred.

In an eleventh aspect, alone or in combination with one or more of the first through tenth aspects, adjusting the one or more of the communication scheduling or the measurement configuration includes adjusting the one or more of the communication scheduling or the measurement configuration based at least in part on one or more of a DRX pattern that occurs based at least in part on the DRX timing or a DTX pattern that occurs based at least in part on the DTX timing.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a first network entity (e.g., base station 110, network entity 910) or a second network entity (e.g., neighboring base station, base station 110, network entity 930). The first network entity and/or the second network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 1208. The communication manager 1208 may control and/or otherwise manage one or more operations of the reception component 1202 and/or the transmission component 1204. In some aspects, the communication manager 1208 may include one or more antennas, a modem, a controller/processor, a memory, or a combination thereof, of the network entity described in connection with FIG. 2. The communication manager 1208 may be, or be similar to, the communication manager 150 depicted in FIGS. 1 and 2. For example, in some aspects, the communication manager 1208 may be configured to perform one or more of the functions described as being performed by the communication manager 150. In some aspects, the communication manager 1208 may include the reception component 1202 and/or the transmission component 1204. The communication manager 1208 may include an activity component 1210 and/or an adjustment component 1212, among other examples.

In some aspects, the apparatus 1200 may be configured to perform one or more operations described herein in connection with FIGS. 1-9. Additionally, or alternatively, the apparatus 1200 may be configured to perform one or more processes described herein, such as process 1000 of FIG. 10, process 1100 of FIG. 11, or a combination thereof. In some aspects, the apparatus 1200 and/or one or more components shown in FIG. 12 may include one or more components of the network entity described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network entity described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network entity described in connection with FIG. 2. In some aspects, the transmission component 1204 may be co-located with the reception component 1202 in a transceiver.

In some aspects, if the apparatus 1200 is the first network entity, the transmission component 1204 may transmit a first message to a second network entity, where the first message indicates one or more of a DRX timing of the first network entity or a DTX timing of the first network entity. The activity component 1210 may start at least one of a DRX mode according to the DRX timing or a DTX mode according to the DTX timing.

The transmission component 1204 and/or the reception component 1202 may communicate based at least in part on the DRX timing or the DTX timing. The reception component 1202 may receive, from the second network entity, a second message associated with accepting or not accepting the one or more of the DRX timing or the DTX timing indicated in the first message.

In some aspects, if the apparatus 1200 is the second network entity or acting as a neighboring network entity, the reception component 1202 may receive, from a first network entity, a first message that indicates one or more of a DRX timing of the first network entity or a DTX timing of the first network entity. The adjustment component 1212 may adjust one or more of communication scheduling or a measurement configuration based at least in part on the one or more of the DRX timing or the DTX timing.

The transmission component 1204 may transmit, to the first network entity, a second message associated with accepting or not accepting the one or more of the DRX timing or the DTX timing indicated in the first message.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by an apparatus of a first network entity, comprising: transmitting a first message to a second network entity, wherein the first message indicates one or more of a discontinuous reception (DRX) timing of the first network entity or a discontinuous transmission (DTX) timing of the first network entity; and starting at least one of a DRX mode according to the DRX timing or a DTX mode according to the DTX timing.
Aspect 2: The method of Aspect 1, further comprising communicating based at least in part on the DRX timing or the DTX timing.
Aspect 3: The method of Aspect 1 or 2, wherein the first message indicates that the DRX timing and the DTX timing are the same and indicates a starting slot and an ending slot for the DRX timing and the DTX timing.
Aspect 4: The method of Aspect 1 or 2, wherein the first message indicates one or more of: a starting slot and an ending slot for the DRX timing, or a starting slot and an ending slot for the DTX timing.
Aspect 5: The method of any of Aspects 1-4, wherein the DRX timing includes a periodicity of the DRX mode or the DTX timing includes a periodicity of the DTX mode.
Aspect 6: The method of any of Aspects 1-5, wherein the first message indicates a DTX starting offset of a DTX cycle or a DRX starting offset of a DRX cycle.
Aspect 7: The method of any of Aspects 1-6, wherein the first message is a node configuration update message.
Aspect 8: The method of any of Aspects 1-6, wherein the first message is dedicated to network entity transmission or reception activity.
Aspect 9: The method of any of Aspects 1-8, further comprising receiving, from the second network entity, a second message associated with accepting or not accepting the one or more of the DRX timing or the DTX timing indicated in the first message.
Aspect 10: The method of Aspect 9, wherein the second message is a node configuration update acknowledge message.
Aspect 11: The method of Aspect 9, wherein the second message is dedicated to providing a response associated with network entity transmission or reception activity.
Aspect 12: The method of any of Aspects 9-11, wherein starting the at least one of the DRX mode or the DTX mode includes starting the at least one of the DRX mode according to the DRX timing or the DTX mode according to the DTX timing based at least in part on the second message indicating acceptance of the DRX timing or the DTX timing.
Aspect 13: The method of any of Aspects 1-12, wherein the first message indicates one or more of: a semi-persistent pattern or a dynamic pattern for DTX; or a semi-persistent pattern or a dynamic pattern for DRX.
Aspect 14: The method of Aspect 13, wherein the first message indicates a first slot for the dynamic pattern for DTX, and wherein the first slot has already occurred.
Aspect 15: A method of wireless communication performed by an apparatus of a second network entity, comprising: receiving, from a first network entity, a first message that indicates one or more of a discontinuous reception (DRX) timing of the first network entity or a discontinuous transmission (DTX) timing of the first network entity; and adjusting one or more of communication scheduling or a measurement configuration based at least in part on the one or more of the DRX timing or the DTX timing.
Aspect 16: The method of Aspect 15, wherein the first message indicates that the DRX timing and the DTX timing are the same and indicates a starting slot and an ending slot for the DRX timing and the DTX timing.
Aspect 17: The method of Aspect 15, wherein the first message indicates one or more of: a starting slot and an ending slot for the DRX timing, or a starting slot and an ending slot for the DTX timing.
Aspect 18: The method of any of Aspects 15-17, wherein the first message is a node configuration update message.
Aspect 19: The method of any of Aspects 15-17, wherein the first message is dedicated to network entity transmission or reception activity.
Aspect 20: The method of any of Aspects 15-19, further comprising transmitting, to the first network entity, a second message associated with accepting or not accepting the one or more of the DRX timing or the DTX timing indicated in the first message.
Aspect 21: The method of Aspect 20, further comprising one or more of adjusting communication scheduling, starting a DRX mode, starting a DTX mode, or adjusting measurements based at least in part on the second message indicating acceptance of the DRX timing or the DTX timing.
Aspect 22: The method of Aspect 20 or 21, wherein the second message is a node configuration update acknowledge message.
Aspect 23: The method of Aspect 20 or 21, wherein the second message is dedicated to providing a response associated with network entity transmission or reception activity.
Aspect 24: The method of any of Aspects 15-23, wherein the first message indicates one or more of: a semi-persistent pattern or a dynamic pattern for DTX; or a semi-persistent pattern or a dynamic pattern for DRX.
Aspect 25: The method of Aspect 24, wherein the first message indicates a first slot for the dynamic pattern for DTX, and wherein the first slot has already occurred.
Aspect 26: The method of any of Aspects 15-25, wherein adjusting the one or more of the communication scheduling or the measurement configuration includes adjusting the one or more of the communication scheduling or the measurement configuration based at least in part on one or more of a DRX pattern that occurs based at least in part on the DRX timing or a DTX pattern that occurs based at least in part on the DTX timing.
Aspect 27: An apparatus for wireless communication at a device, comprising a processor; memory coupled with the processor; and instructions stored in the memory and executable by the processor to cause the apparatus to perform the method of one or more of Aspects 1-26.
Aspect 28: A device for wireless communication, comprising a memory and one or more processors coupled to the memory, the one or more processors configured to perform the method of one or more of Aspects 1-26.
Aspect 29: An apparatus for wireless communication, comprising at least one means for performing the method of one or more of Aspects 1-26.
Aspect 30: A non-transitory computer-readable medium storing code for wireless communication, the code comprising instructions executable by a processor to perform the method of one or more of Aspects 1-26.
Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus of a first network entity for wireless communication, comprising:
one or more memories; and
one or more processors coupled to the one or more memories, the one or more processors individually or collectively configured to cause the first network entity to:
transmit a first message to a second network entity, wherein the first message indicates one or more of a discontinuous reception (DRX) timing of the first network entity or a discontinuous transmission (DTX) timing of the first network entity; and
start at least one of a DRX mode according to the DRX timing or a DTX mode according to the DTX timing.

2. The apparatus of claim 1, wherein the one or more processors are individually or collectively configured to cause the first network entity to communicate based at least in part on the DRX timing or the DTX timing.

3. The apparatus of claim 1, wherein the first message indicates that the DRX timing and the DTX timing are the same and indicates a starting slot and an ending slot for the DRX timing and the DTX timing.

4. The apparatus of claim 1, wherein the DRX timing includes a periodicity of the DRX mode or the DTX timing includes a periodicity of the DTX mode.

5. The apparatus of claim 1, wherein the first message indicates a DTX starting slot offset of a DTX cycle or a DRX starting slot offset of a DRX cycle.

6. The apparatus of claim 1, wherein the first message indicates one or more of:
a starting slot and an ending slot for the DRX timing, or
a starting slot and an ending slot for the DTX timing.

7. The apparatus of claim 1, wherein the first message is a node configuration update message.

8. The apparatus of claim 1, wherein the first message is dedicated to network entity transmission or reception activity.

9. The apparatus of claim 1, wherein the one or more processors are individually or collectively configured to cause the first network entity to receive, from the second network entity, a second message associated with accepting or not accepting the one or more of the DRX timing or the DTX timing indicated in the first message.

10. The apparatus of claim 9, wherein the second message is a node configuration update acknowledge message.

11. The apparatus of claim 9, wherein the second message is dedicated to providing a response associated with network entity transmission or reception activity.

12. The apparatus of claim 9, wherein the one or more processors, to start the at least one of the DRX mode or the DTX mode, are individually or collectively configured to cause the first network entity to start the at least one of the DRX mode according to the DRX timing or the DTX mode according to the DTX timing based at least in part on the second message indicating acceptance of the DRX timing or the DTX timing.

13. The apparatus of claim 1, wherein the first message indicates one or more of:
a semi-persistent pattern or a dynamic pattern for DTX; or
a semi-persistent pattern or a dynamic pattern for DRX.

14. The apparatus of claim 13, wherein the first message indicates a first slot for the dynamic pattern for DTX, and wherein the first slot has already occurred.

15. An apparatus of a second network entity for wireless communication, comprising:
one or more memories; and
one or more processors coupled to the one or more memories, the one or more processors individually or collectively configured to cause the second network entity to:
receive, from a first network entity, a first message that indicates one or more of a discontinuous reception (DRX) timing of the first network entity or a discontinuous transmission (DTX) timing of the first network entity; and
adjust one or more of communication scheduling or a measurement configuration based at least in part on the one or more of the DRX timing or the DTX timing.

16. The apparatus of claim 15, wherein the first message indicates that the DRX timing and the DTX timing are the same and indicates a starting slot and an ending slot for the DRX timing and the DTX timing.

17. The apparatus of claim 15, wherein the first message indicates one or more of:
a starting slot and an ending slot for the DRX timing, or
a starting slot and an ending slot for the DTX timing.

18. The apparatus of claim 15, wherein the first message is a node configuration update message.

19. The apparatus of claim 15, wherein the first message is dedicated to network entity transmission or reception activity.

20. The apparatus of claim 15, wherein the one or more processors are individually or collectively configured to cause the second network entity to transmit, to the first network entity, a second message associated with accepting or not accepting the one or more of the DRX timing or the DTX timing indicated in the first message.

21. The apparatus of claim 20, wherein the one or more processors are individually or collectively configured to cause the second network entity to one or more of adjust communication scheduling, start a DRX mode, start a DTX mode, or adjust measurements based at least in part on the second message indicating acceptance of the DRX timing or the DTX timing.

22. The apparatus of claim 20, wherein the second message is a node configuration update acknowledge message.

23. The apparatus of claim 20, wherein the second message is dedicated to providing a response associated with network entity transmission or reception activity.

24. The apparatus of claim 15, wherein the first message indicates one or more of:
a semi-persistent pattern or a dynamic pattern for DTX; or
a semi-persistent pattern or a dynamic pattern for DRX.

25. The apparatus of claim 24, wherein the first message indicates a first slot for the dynamic pattern for DTX, and wherein the first slot has already occurred.

26. The apparatus of claim 15, wherein the one or more processors, to adjust the one or more of the communication scheduling or the measurement configuration, are individually or collectively configured to cause the second network entity to adjust the one or more of the communication scheduling or the measurement configuration based at least in part on one or more of a DRX pattern that occurs based at least in part on the DRX timing or a DTX pattern that occurs based at least in part on the DTX timing.

27. A method of wireless communication performed by an apparatus of a first network entity, comprising:
transmitting a first message to a second network entity, wherein the first message indicates one or more of a discontinuous reception (DRX) timing of the first network entity or a discontinuous transmission (DTX) timing of the first network entity; and
starting at least one of a DRX mode according to the DRX timing or a DTX mode according to the DTX timing.

28. The method of claim 27, wherein the first message indicates that the DRX timing and the DTX timing are the same and indicates a starting slot and an ending slot for the DRX timing and the DTX timing.

29. The method of claim 27, wherein the first message indicates one or more of:
a starting slot and an ending slot for the DRX timing, or
a starting slot and an ending slot for the DTX timing.

30. A method of wireless communication performed by an apparatus of a second network entity, comprising:
receiving, from a first network entity, a first message that indicates one or more of a discontinuous reception (DRX) timing of the first network entity or a discontinuous transmission (DTX) timing of the first network entity; and
adjusting one or more of communication scheduling or a measurement configuration based at least in part on the one or more of the DRX timing or the DTX timing.
